(19) United States
(12) Patent Application Publication
(10) Pub. No.: US 2009/0162068 A1
(43) Pub. Date: Jun. 25, 2009

(54) POLARIZATION MODE DISPERSION COMPENSATION CIRCUIT

(75) Inventors: Shigeki Wada, Tokyo (JP); Jin Yamazaki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Minato-ku (JP)

(21) Appl. No.: 12/065,412

(22) PCT Filed: Aug. 28, 2006
(86) PCT No.: PCT/JP2006/316848

§ 371 Date: Feb. 29, 2008

(30) Foreign Application Priority Data
Sep. 2, 2005 (JP) 2005-255274

(51) Int. Cl. H04J 14/00

(52) U.S. Cl. 398/81

(57) ABSTRACT

An object of the present invention is to realize a compensation circuit which can cope with rapidly fluctuating polarization mode dispersion, and the configuration thereof is a polarization dispersion compensation circuit for compensating polarization mode dispersion which takes place when a signal propagates on a transmission path, characterized by comprising: a front-end compensation part configured as a transversal filter for shaping a waveform subjected to polarization mode dispersion; and a data tracking/recovery part including a PLL-type data recovery circuit having a loop frequency band higher than the fluctuation frequency of polarization mode dispersion, and that tracks the temporal fluctuation of the polarization mode dispersion to recover data.

### TECHNICAL FIELD

The present invention relates to the field of digital signal transmission by optical means, and particularly to a polarization mode dispersion compensation circuit for electrically shaping optical signal distortions caused by polarization dispersion of an optical fiber.

### BACKGROUND ART

Polarization mode dispersion (PMD) refers to the phenomena where there is a difference in the propagation time between two polarization modes which constitute principal axes when an optical fiber or an optical device used in a transmission path has polarization dependence. Also, the amount of polarization mode dispersion is characterized by two principal states of polarization (PSP) and differential group delay (DGD) between modes in the transmission path. Since a received optical signal is observed as the sum of waveforms of both modes, the waveform is distorted thereby causing degradation of reception sensitivity and transmission characteristics. Further, since PSP and DGD of the transmission path vary depending on the pressure and vibration applied to the optical fiber or the temperature thereof as well, the amount of the degradation caused by polarization mode dispersion dynamically fluctuates in a random manner.

FIG. 4 illustrates the degradation of waveform due to fluctuating polarization mode dispersion.

It is shown in FIG. 4(a) that a signal of which the fast axis and the slow axis coincide before propagation in optical fiber 401, as shown in the left side of the figure, is output in a state in which the fast axis and the slow axis are shifted in time after propagation in optical fiber 401 since there is a difference in the propagation time between the two polarization modes of optical fiber 401. FIG. 4(b) shows the manner in which an optical signal shown in FIG. 4(a) is replaced by an electrical signal; where the signal which is interpreted as “1”, “0” with its height being 1 before propagation is converted after propagation into a signal having heights of 1-γ and γ with γ being the branch ratio of the fast axis and the slow axis, thereby being interpreted as “1”, “1”. Such a time difference between the fast axis and the slow axis is the differential group delay.

FIG. 4(c) shows dynamically fluctuating polarization mode dispersion. The two principal polarization states and the differential group delay, which characterize polarization mode dispersion, also vary depending on the pressure and vibration applied to the optical fiber or on the temperature thereof, and the branch ratio γ and the differential group delay will dynamically fluctuate as shown in FIG. 4(c).

FIG. 4(d) shows an EYE opening which indicates a degraded waveform due to fluctuating polarization mode dispersion.

In order to compensate the polarization mode dispersion having the above described characteristics, a method of using an optical dispersion compensation device, or a method of electrically compensating dispersion using a digital filter has been used.

Further, as described in Japanese Patent Laid-Open No. 2004-356742, simple feedback control schemes also have been devised such as one in which a degraded waveform is detected by asynchronous sampling and the degree of the degradation thereof is calculated to control a dispersion compensator by using a control circuit.

Patent Document 1: Japanese Patent Laid-Open No. 2004-356742

As a related art method for compensating polarization mode dispersion, a method of using an optical dispersion compensation device, or a method of electrically compensating dispersion using a digital filter is being employed. However, it is well known that the typical fluctuation rate of degradation is about no more than a millisecond and a commonly used optical compensation device, which is based primarily on temperature control, cannot follow this rate. Also the combination of an adaptive filter and an adaptation algorithm, which is often used in digital signal processing, has a problem in that it is difficult to perform sufficient compensation to cope with fluctuations in a high-rate communication exceeding 10 Gbps because of its rapidity.

Further, as described in Japanese Patent Laid-Open No. 2004-356742, a simple feedback control scheme, in which a degraded waveform is detected by asynchronous sampling and the degree of the degradation thereof is calculated to control a dispersion compensator by a control circuit, still has problems in the rapidity of feedback control to cope with polarization mode dispersion fluctuating at a high rate, such that the sampling for determining the degree of degradation takes time, and that the arithmetic operation for controlling the compensator also takes time.

The present invention has been made in view of the above described problems of related art, and its object is to realize a compensation circuit capable of coping with polarization mode dispersion fluctuating at a high rate.

### DISCLOSURE OF THE INVENTION

The polarization mode dispersion compensation circuit according to the present invention is a polarization mode dispersion compensation circuit for compensating the polarization mode dispersion which takes place when a signal propagates in a transmission path, characterized by comprising:

a front-end compensation part configured as a transversal filter for shaping a waveform subjected to polarization mode dispersion; and

a data tracking/recovery part, including a PLL-type data recovery circuit having a loop frequency band higher than the fluctuation frequency of polarization mode dispersion, and that tracks the temporal fluctuation of polarization mode dispersion to recover data.

A polarization mode dispersion compensation circuit according to another embodiment of the present invention is a polarization mode dispersion compensation circuit for compensating polarization mode dispersion which takes place when a signal propagates in a transmission path, characterized by comprising:

a front-end compensation part configured as a transversal filter for shaping a waveform subjected to polarization mode dispersion; and

a data tracking/recovery part including a PLL-type clock-data recovery circuit having a loop frequency band higher than the fluctuation frequency of polarization mode dispersion and that tracks the temporal fluctuation of polarization mode dispersion to recover data.

In this case, the front-end compensation part may be made up of a linear equalizer which is a kind of digital filter.

Further, the weighting factor for the front-end compensation part may be set such that the output of the front-end compensation part forms an EYE opening throughout the fluctuation range of the polarization mode dispersion, and the opening has an output amplitude which can be discriminated as data at the data tracking/recovery part.

Furthermore, the loop frequency band of the above described data tracking part may be configured to be variable up to a frequency higher than the fluctuation frequency of polarization mode dispersion.

Further, the weighting factor for the front-end compensation part may be set such that the EYE opening of the front-end compensation part that is output becomes maximum upon the incidence of an optical signal having a branch ratio of 40% to 60%.

Further, the weighting factor for the front-end compensation part may be determined by monitoring the waveform degradation when the branch ratio of optical input is varied.

Further, a controller may be provided for setting the weighting factor for the above described front-end compensation part.

Further, the controller may be configured such that the front-end compensation part determines the weighting factor for the front-end compensation part depending on the output of the front-end compensation part.

Further, the controller may be configured so as to vary the input voltage of the above described data tracking/recovery circuit depending on the error rate of the data tracking/recovery circuit output.

In association with the fluctuation of polarization mode dispersion, the waveform itself becomes disturbed as PSP varies and further the signal timing becomes shifted within the time range corresponding to the MAX value of the DGD amount of the transmission line, thereby causing the waveform to be further disturbed.

In the present invention, the front-end compensation part is configured as a transversal filter. The weighting factor for the transversal filter is set in such a way that the waveform is shaped not to a degree at which an optimum value for each individual PSP value (at this moment, DGD is also determined from the transmission fiber characteristics) is obtained, but to a degree at which the waveform can be discriminated at all PSP values by the data tracking/recovery part in the next stage. Further by making the loop frequency band of the synchronous-type data tracking/recovery part higher than the fluctuation frequency of polarization mode dispersion, the time shift which takes place when PSP fluctuates in time can be followed. By the configuration of the present invention which requires neither any sampling time nor arithmetic operation time, it is possible to realize an error-free compensated waveform even when a very high rate PMD (PSP, DGD) takes place caused by contact with the fiber or caused by vibration of the fiber.

### BRIEF DESCRIPTION OF THE DRAWINGS

FIG. 1 is a configuration diagram to show a first exemplary embodiment of the present invention;

FIG. 2 shows the configuration of the front-end compensation part of the present invention;

FIG. 3 shows a configuration of the data tracking/recovery part of the present invention;

FIG. 4 shows the manner in which a signal waveform is distorted by polarization mode dispersion;

FIG. 5 shows an output waveform compensated by a front-end compensation circuit;

FIG. 6 shows the effects of the present invention;

FIG. 7 is a configuration diagram to show a second exemplary embodiment of the present invention;

FIG. 8 shows an output waveform compensated by the front-end compensation circuit, and a threshold for the data tracking/recovery part; and

FIG. 9 shows a second exemplary configuration of the data tracking/recovery part of the present invention.

### DESCRIPTION OF SYMBOLS

101 Optical fiber
102 Photodiode
103 Transimpedance-type amplifier
104 Polarization mode dispersion compensation circuit
105 Front-end compensation part
106 Data tracking/recovery part
107 CDR/DEMUX part
301, 307 Amplifier
302 Delay unit
303 Discriminator
304 Phase comparator
305 VCO
306 Loop filter

### BEST MODE FOR CARRYING OUT THE INVENTION

Hereinafter, the present invention will be described in more detail with reference to appended drawings.

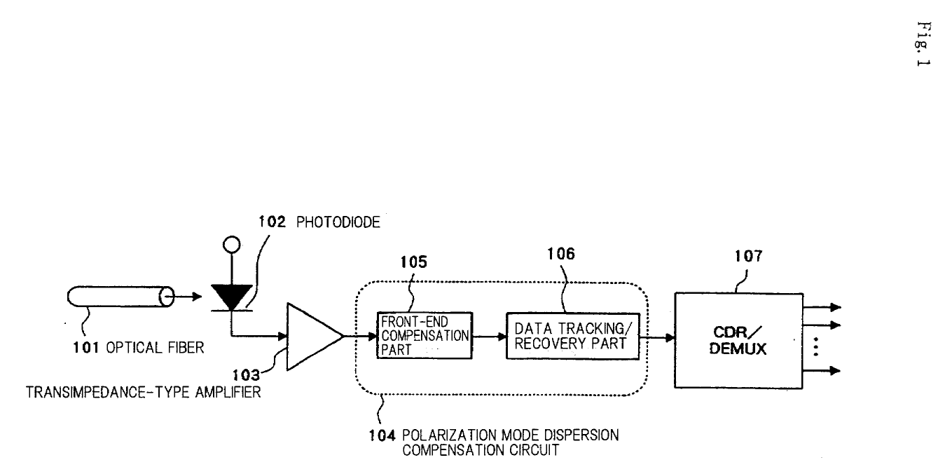

An exemplary embodiment of the present invention will be described. The embodiment of the present invention is configured as shown in FIG. 1 such that a front-end module made up of a photodiode and a transimpedance-type amplifier is placed at the reception part of an optical fiber. Further, by arranging at the next stage, a front-end compensation part and further a polarization mode dispersion compensation circuit made up of a data tracking/recovery circuit, it is possible to prevent signal errors caused by dynamic fluctuation of polarization mode dispersion.

Hereinafter, description will be made using specific embodiments.

### Embodiment 1

FIGS. 1, 2, and 3 are circuit diagrams to show a polarization mode dispersion compensation circuit of a first exemplary embodiment of the present invention.

The polarization mode dispersion compensation circuit of FIG. 1 is made up of photodiode 102, polarization mode dispersion compensation circuit 104 comprising front-end compensation part 105, and clock-data recovery/demultiplexing circuit (CDR/DEMUX) 107.

Photodiode 102 receives an optical transmission signal transmitted via optical fiber 101 and converts it from an optical signal to an electrical signal. Transimpedance-type amplifier 103 amplifies the electrical signal converted by photodiode 102. Front-end compensation part 105 shapes the waveform of the electrical signal amplified by transimpedance-type amplifier 103. Data tracking/recovery part 106 causes the waveform shaped by front-end compensation part 105 to follow the fluctuation of polarization mode dispersion. CDR/DEMUX 107 extracts low-rate data from the recovered, compensated signal data, which is the output of data tracking/recovery part 106.

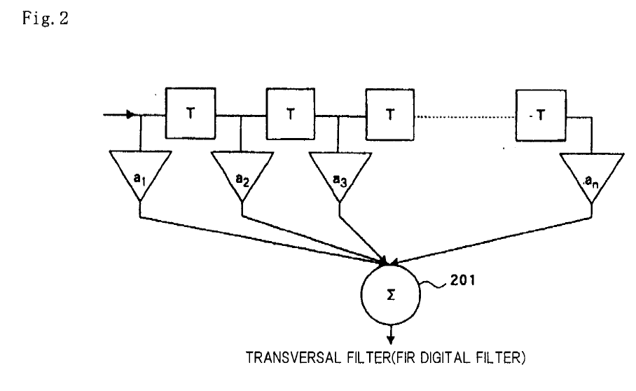

FIG. 2 is a block diagram to show a configuration example of front-end compensation part 105. Front-end compensation part 105 is a transversal filter making up a linear equalizer (also called FFE: Feed-forward Equalizer, or FIR filer: Finite Impulse Reaction filter, depending on the circuit configuration), which is made up of a plurality of delay lines T whose delay time is set to be ½ of bit rate period, weighting amplifiers a₁ to aₙ, and adder 201.

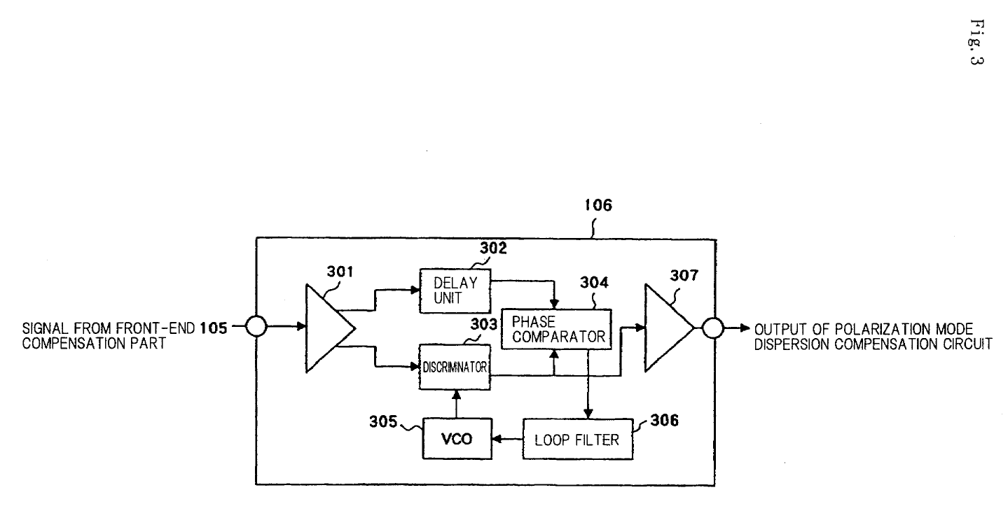

FIG. 3 is a block diagram to show a configuration example of data tracking/recovery part 106. Data tracking/recovery part 106 is made up of amplifiers 301 and 307, delay unit 302, discriminator 303, phase comparator 304, voltage controlled oscillator (VCO) 305, and loop filter 306 as shown in FIG. 3.

Amplifier 301 amplifies the signal from front-end compensation part 105 and provides it to discriminator 303 and delay unit 302. Delay unit 302 delays the input signal by a predetermined time period and thereafter outputs it to phase comparator 304. Discriminator 303 is a holding circuit made up of a D flip-flop of whose Cₚ input is the output of VCO 305, and its output is input to phase comparator 304 and amplifier 307.

Delay unit 302, discriminator 303, phase comparator 304, VCO 305, and loop filter 306 make up a PLL (Phase-Locked Loop) circuit, and data tracking/recovery circuit 106 makes up a PLL-type data recovery (DR) circuit.

Phase comparator 304 compares the phases of data output of discriminator 303 and delay unit 302 to control the oscillation frequency of VCO 305. Thereby, the output of discriminator 303 comes to have the same phase as that of the output of delay unit 302, and is amplified by amplifier 307 to provide the output of polarization mode dispersion compensation circuit 104.

In data tracking/recovery part 106, the frequency band of loop filter 306 is set to be higher than the dispersion fluctuation frequency (typically several to hundreds of kHz) to follow the fluctuation of polarization mode dispersion.

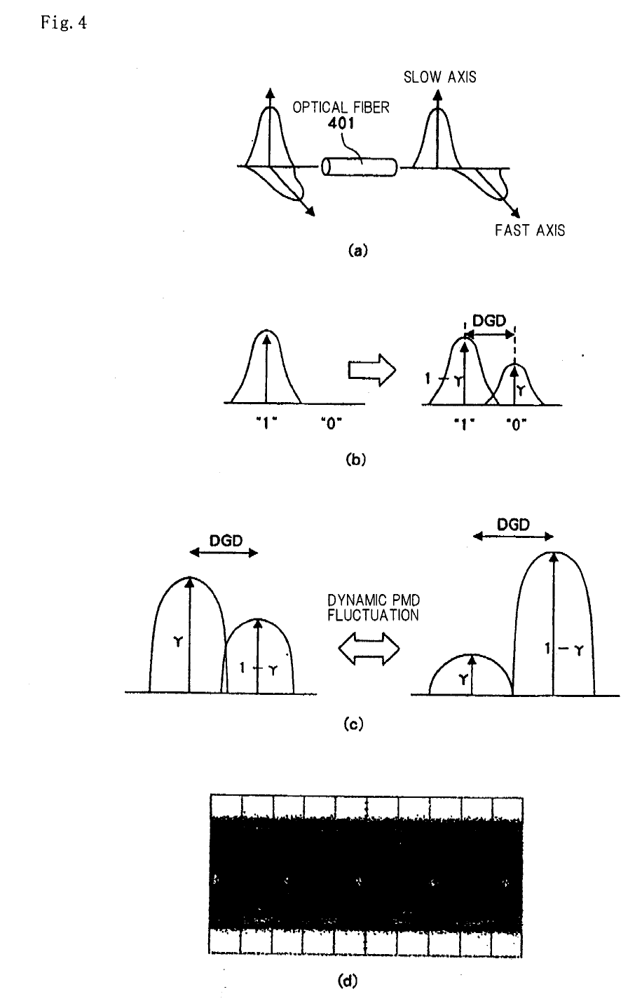

As shown in FIG. 4(c), the fluctuation of polarization mode dispersion is characterized in that it causes the waveform itself to be disturbed as PSP varies, and also causes the signal timing to be shifted within the time range corresponding to the MAX value of the DGD amount of the transmission line thereby causing the waveform to be further disturbed. In this regard, the set value for the weighting factor for above described front-end compensation part 105 is specified in such a way that the waveform is shaped not into an optimum value for each individual PSP value (at this time, DGD as well is determined from the transmission fiber characteristics), but into a waveform which can be discriminated at all PSP values by data tracking/recovery part 106 in the next stage, and is fixed. In the case of such a setting, the output of front-end compensation part 105 will become a compensated waveform which has an EYE opening that is higher than or equal to the input sensitivity of data tracking/recovery part 206 in the next stage.

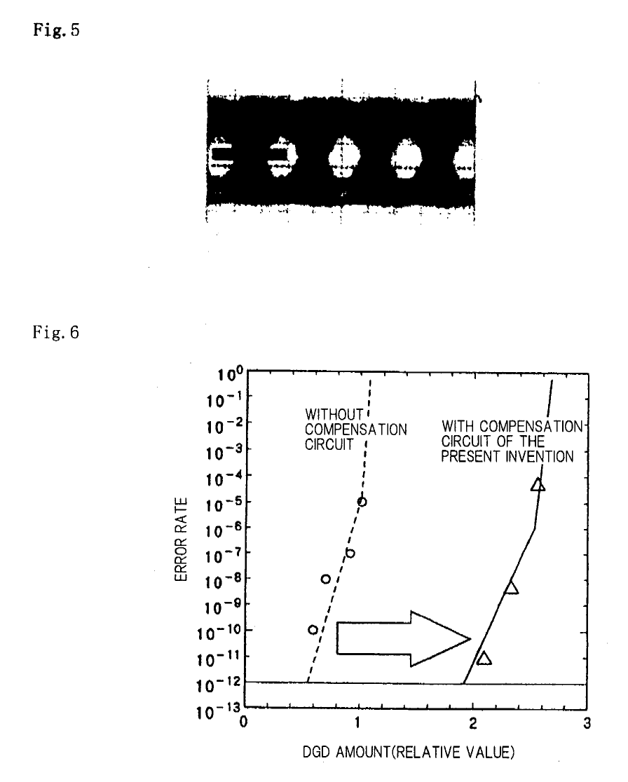

In the above described embodiment, each TAP factor of the transversal filter shown in FIG. 2, and that make up the front-end compensation part 105 is controlled such that the EYE waveform of the output is discriminable in data tracking/recovery part 106 as shown in FIG. 5.

On the other hand, in data tracking/recovery part 106, a stable compensated waveform is output, which can follow the time shift generated when PSP fluctuates in time and thus generates no time shift even when temporal fluctuation occurs. This makes it possible to realize an error-free compensated waveform even when PMD (PSP, DGD) takes place.

FIG. 6 shows the results of evaluation of polarization dispersion tolerances for cases in which the polarization dispersion compensation circuit, according to the present embodiment, is used and in which it is not used. As seen in FIG. 6, by using the circuit of the present embodiment, the dispersion tolerance (specified by error rate <1E-12) is improved by about three times.

Furthermore, data tracking/recovery part 106 may be a clock-data recovery (CDR) circuit having a loop frequency band higher than the PMD fluctuating frequency, or a demultiplexing circuit (DEMUX) or a deserializer containing a CDR having the above described characteristics, and a front-end compensator may be provided in the preceding stage thereof. Further, in the present embodiment, although an example based on an NRZ (Non return-to-zero) signal has been shown, the present invention may be applicable to any transmission scheme such as CSRZ (Carrier Suppressed RZ), Duo-binary, DPSK (Differential Phase Shift Keying), etc.

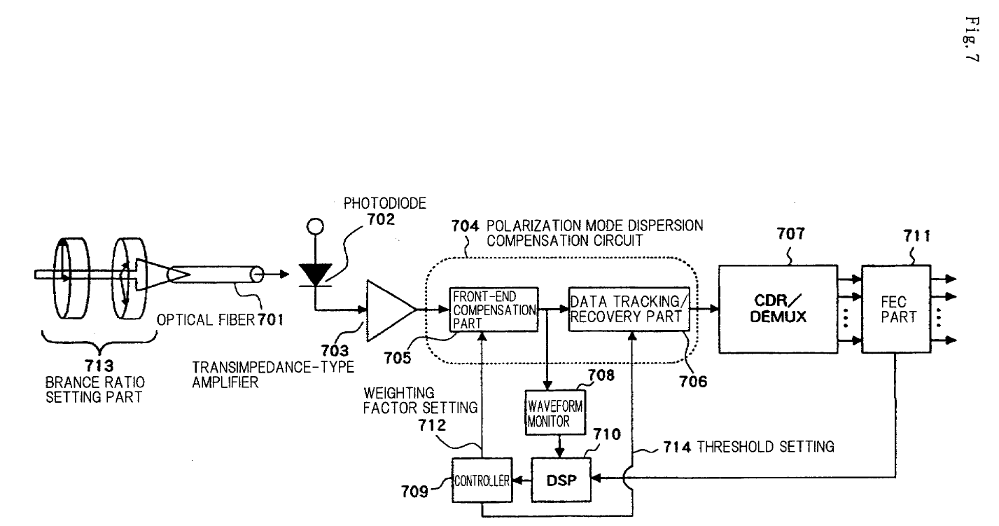

Next, using FIG. 7, a polarization mode dispersion compensation circuit of a second embodiment of the present invention will be described.

The polarization mode dispersion compensation circuit shown in FIG. 7 is made up of: photodiode 702 for receiving an optical transmission signal propagating through optical fiber 701 at a predetermined branch ratio set by branch ratio setting part 713 and converting it from an optical signal into an electrical signal; transimpedance-type amplifier 703 for amplifying the electrical signal; front-end compensation part 705 for shaping the waveform of the electrical signal amplified by transimpedance-type amplifier 703; data tracking/recovery part 706 making up polarization mode dispersion compensation circuit 706 along with front-end compensation part 705, the data tracking/recovery part 706 being provided the output waveform compensated through front end to lock front-end compensation part 705 and to follow the fluctuation of polarization mode dispersion and being added with a function of adjusting the amplification factor; clock-data recovery/demultiplexing circuit (CDR/DEMUX) 707 for extracting low-rate coded data from compensated signal data recovered; forward error correction (EFC) part 711 for generating accurate signals from the coded low-rate data and determining errors of the transmitted signal; waveform monitor 708 for determining the degree of degradation of dispersion waveform in the output of front-end compensation part 705; digital signal processing processor (DSP) 710 for performing arithmetic operations based on the error determination result of transmitted signal in FEC part 711 and the determined signal from waveform monitor 708; and controller 709 for controlling the weighting factor for front-end compensation part 705 based on the arithmetic processing result at DSP 710 and for determining the threshold for adjusting the amplification factor of data tracking/recovery part 706.

The configurations and operations of polarization mode dispersion compensation circuit 704 made up of photodiode 702, front-end compensation part 705 and data tracking/recovery part 706, and clock-data recovery/demultiplexing circuit (CDR/DEMUX) 707 are the same as those of photodiode 102, polarization mode dispersion compensation circuit 104 made up of front-end compensation part 105 and data tracking/recovery part 106, and clock-data recovery/demultiplexing circuit (CDR/DEMUX) 107 shown in FIG. 1.

Front-end compensation part 705 is made up of a plurality of delay lines T whose delay time is set to be ½ of the bit rate period, weighting amplifiers a₁ to aₙ, and adder 201 as shown in FIG. 2.

FIG. 9 is a block diagram to show the configuration of data tracking/recovery part 706; in the figure, the configurations and operations of amplifier 907, delay unit 902, discriminator 903, phase comparator 904, voltage controlled oscillator (VCO) 905, and loop filter 906 are similar to those of amplifier 307, delay unit 302, discriminator 303, phase comparator 304, voltage controlled oscillator (VCO) 305, and loop filter 306 shown in FIG. 3.

Amplifier 901 in the present embodiment is configured as a differential amplifier, to one of which a signal from front-end compensation part 705 is input and to the other of which a threshold setting 714 determined by controller 709 is input.

In the present embodiment as well, to make data tracking/recovery part 706 follow the fluctuation of polarization mode dispersion, the frequency band of loop filter 906 is set to be higher than the dispersion fluctuation frequency (typically several to hundreds of kHz).

As described above, the fluctuation of polarization mode dispersion is characterized in that it causes the waveform itself to be disturbed as PSP varies, as shown in FIG. 4(c), and also causes the signal timing to be shifted within the time range corresponding to the MAX value of the DGD amount in the transmission line, thereby causing the waveform to be further disturbed. Therefore, in the polarization mode dispersion compensation circuit and transmission apparatus of the present embodiment, an optical signal in the range of a branch ratio of 40% to 60% with respect to the average DGD value of the transmission line is transmitted by branch ratio setting part 713.

The state of the optical signal after propagation in optical fiber 701 is set by controller 709.

Regarding the dispersion waveform output by waveform monitor 708, DSP 710 computes the proportion of “0” and “1” or the peak-to-peak value thereof which indicates the degree of its degradation. Further, DSP 710 computes an error rate from the result of error determination of the transmission signal output by EEC part 711.

Controller 709 determines weighting factor setting 712 of front-end compensation part 705, and threshold setting 714 of data tracking/recovery part 706 based on the computation result of DSP 710.

The determinations of weighting factor setting 712 and threshold setting 714 are performed in a training step. Based on the degree of degradation of the dispersion waveform output by waveform monitor 708 and the error determination result of the transmission signal output by FEC part 711, weighting factor setting 712 of front-end compensation part 705 is determined such that the EYE opening becomes maximum and the error rate becomes minimum, and threshold setting 714 of the threshold adjusting function of input signal at data tracking/recovery part 706 is determined, thereafter fixing those values.

Although weighting factor setting 712 is determined such that the proportion of “0” and “1” of dispersion waveform becomes 1:1, it may be determined such that the peak-to-peak value of dispersion waveform becomes maximum. Further, these determination methods may be used in combination by applying weighting to them. As a result of this, it becomes possible to maximize EYE opening.

Regarding threshold setting 714, it is determined such that the error rate will not become less than or equal to a predetermined value. This will cause the input voltage at amplifier 901 to be changed thereby making it possible to minimize the error rate.

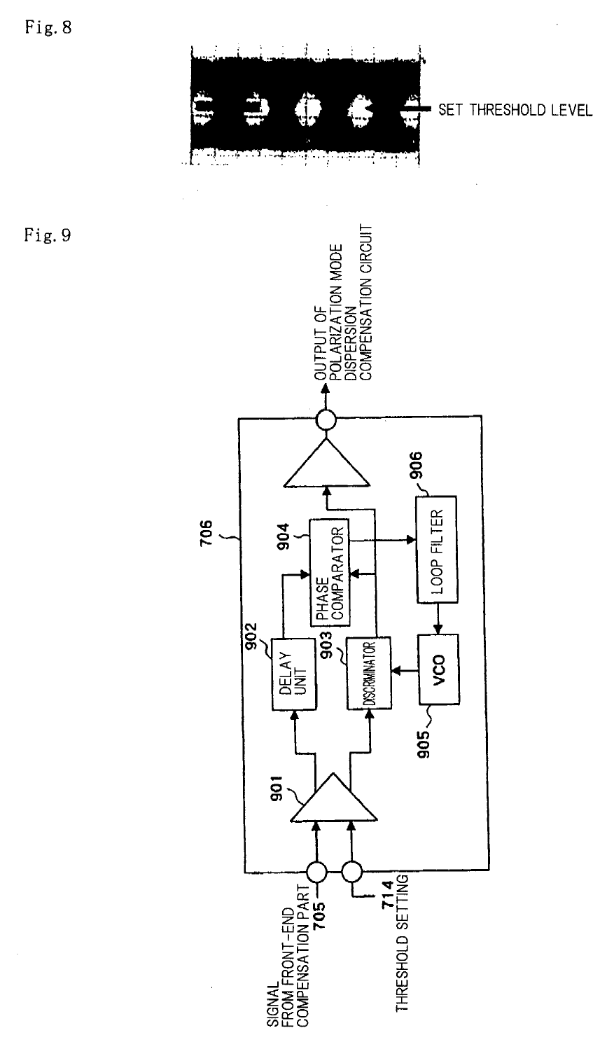

FIG. 8 shows an example in which each TAP factor is controlled by weighting factor setting 712 which is determined in the above described training step and provides an initial value, so that the EYE waveform of output is made to be discriminable by data tracking/recovery part 706, and thus threshold setting 714 is performed.

On the other hand, in data tracking/recovery part 706, it is possible to compensate the time shift and amplitude variation caused by dispersion rapidly fluctuating in time associated with fiber contact, fiber vibration etc., and thus a stable compensated waveform without temporal fluctuation will be output. Thereby, it is possible to realize an error-free compensated waveform even when high-rate PMD (PSP, DGD) fluctuation takes place which cannot be coped with by related arts.

In the present embodiment as well as in the first embodiment, the data shown in FIG. 6 have been obtained as the result of estimating the polarization dispersion tolerances in the cases in which the polarization dispersion compensation circuit according to the present embodiment is used and in which it is not used. As seen in FIG. 6, using the circuit of the present embodiment has improved the dispersion tolerance (specified by error rate <1E-12) by three times even when it fluctuates.

Further, in the present embodiment, although description has been made on the case in which weighting factor setting 712 of front-end compensation part 705, and threshold setting 714 of data tracking/recovery part 706 are fixed to initial values set in the training step, controller 709 may be configured to make it perform the function of controlling weighting factor setting 712 and threshold setting 714 not only during the training step but also during signal transmission so that weighting factor setting 712 and threshold setting 714 are constantly updated.

In the case of the above described configuration, there will be a time difference no less than one digit between the total time required for error determination at FEC part 711, time required for determination from the waveform monitor signal, and the time required for DSP arithmetic processing, and the time required for follow-up control at the data tracking/recovery part. Therefore, only data tracking/recovery part 706 stably operates for high-rate PMD fluctuation, and for temperature fluctuation and relatively slow PMD fluctuation, both control by data tracking/recovery part 706 and control by controller 709 operate stably, making it possible to compensate PMD dispersion.

Further, configuration may be such that data tracking/recovery part 706 is a clock-data recovery (CDR) circuit which has a loop frequency band higher than PMD fluctuation frequency, or DEMUX or deserializer containing a CDR circuit having the above described characteristics, and a front-end compensator is provided in the preceding stage thereof. Further, in the present embodiment, although an example by an NRZ (Non return-to-zero) signal is shown, the present embodiment may be applied to any transmission scheme including RZ (No Return-to-zero), CSRZ (Carrier Suppressed RZ), Duo-binary, DPSK (Differential Phase Shift Keying), etc.

Further, although the present invention has been described in line with the above embodiments, the present invention will not be limited to the configuration of the above described embodiments and of course various variations and modifications which can be achieved by those skilled in the art are intended to be included within the scope of each of the claims of the present invention.

1-10. (canceled)

11. A polarization mode dispersion compensation circuit for compensating polarization mode dispersion which takes place when a signal propagates in a transmission path, characterized by comprising:
a front-end compensation part configured as a transversal filter for shaping a waveform subjected to polarization mode dispersion; and
a data tracking/recovery part including a PLL-type data recovery circuit having a loop frequency band higher than the fluctuation frequency of polarization mode dispersion and that tracks the temporal fluctuation of polarization mode dispersion to recover data.

12. A polarization mode dispersion compensation circuit for compensating polarization mode dispersion which takes place when a signal propagates in a transmission path, characterized by comprising:
a front-end compensation part configured as a transversal filter for shaping a waveform subjected to polarization mode dispersion; and
a data tracking/recovery part including a PLL-type clock-data recovery circuit having a loop frequency band higher than the fluctuation frequency of polarization mode dispersion and that tracks the temporal fluctuation of polarization mode dispersion to recover data.

13. The polarization mode dispersion compensation circuit according to claim 11, characterized in that
said compensation part is made up of a linear equalizer which is a kind of digital filter.

14. The polarization mode dispersion compensation circuit according to claim 11, characterized in that
the weighting factor for the front-end compensation part is set such that the output of said compensation part forms an EYE opening throughout the fluctuation range of polarization mode dispersion and the opening has an output amplitude which can be discriminated as data at the data tracking/recovery part.

15. The polarization mode dispersion compensation circuit according to claim 11, characterized in that
the loop band of said data tracking part is variable to a frequency higher than the fluctuation frequency of polarization mode dispersion.

16. The polarization mode dispersion compensation circuit according to claim 11, characterized in that
the weighting factor for the front-end compensation part is set such that the EYE opening of the front-end compensation part that is output becomes maximum upon incidence of an optical signal having a branch ratio of 40% to 60%.

17. The polarization mode dispersion compensation circuit according to claim 11, characterized in that
the weighting factor for the front-end compensation part is determined by monitoring the waveform degradation when the branch ratio of optical input is varied.

18. The polarization mode dispersion compensation circuit according to claim 11, characterized in that said polarization mode dispersion compensation circuit comprises:
a controller for setting the weighting factor for said front-end compensation part.

19. The polarization mode dispersion compensation circuit according to claim 18, characterized in that
said controller determines the weighting factor for the front-end compensation part depending on the output of the front-end compensation part.

20. The polarization mode dispersion compensation circuit according to claim 18, characterized in that
the controller varies the input voltage of said data tracking/recovery circuit depending on the error rate of said data tracking/recovery circuit.

21. The polarization mode dispersion compensation circuit according to claim 19, characterized in that
the controller varies the input voltage of said data tracking/recovery circuit depending on the error rate of said data tracking/recovery circuit.
